(19) United States
(12) Patent Application Publication
(10) Pub. No.: US 2026/0309562 A1
(43) Pub. Date: Oct. 8, 2026

(54) DEVICE FOR MEASURING CIRCULAR ARC KINETIC ENERGY AND SYSTEM FOR MEASURING DRAGGING FORCE USING THE DEVICE

(71) Applicants: Hyundai Motor Company, Seoul (KR); Kia Corporation, Seoul (KR); PHA Co., Ltd., Daegu (KR)

(72) Inventors: Yeong Hyeon Han, Hwaseong-si (KR); Min Hyung Byun, Hwaseong-si (KR); Ji Ho Choi, Hwaseong-si (KR); Ja Sung Gu, Hwaseong-si (KR); Sang Wook Lee, Hwaseong-si (KR); Won Woo Jeong, Daegu (KR); Seong Tae Hong, Suwon-si (KR)

(21) Appl. No.: 19/098,182

(22) Filed: Apr. 2, 2025

(30) Foreign Application Priority Data
Sep. 23, 2024 (KR) 10-2024-0128352

(51) Int. Cl. G01L 5/00; E05F 15/60

(52) U.S. Cl. CPC G01L 5/0052; E05F 15/60; E05Y 2900/546

(57) ABSTRACT

A kinetic energy measurement device can include an impact energy measurement unit configured to measure impact energy generated in a closing operation of an electric door, and a guide unit configured to support the impact energy measurement unit at a point on an opening or closing trajectory of the electric door. A dragging force measurement system can include the kinetic energy measurement device configured to measure a magnitude of a force generated at an end portion of an electric door in a closing operation of the electric door, a vector value extraction module configured to separate the magnitude of the force measured by the kinetic energy measurement device into a vector value, and a determination reference value setting module configured to set a dragging force determination criterion by measuring a force and energy variation based on the vector value extracted by the vector value extraction module.

### CROSS-REFERENCE TO RELATED APPLICATIONS

This application claims the benefit of Korean Patent Application No. 10-2024-0128352 filed on Sep. 23, 2024, which is hereby incorporated by reference as if fully set forth herein.

### TECHNICAL FIELD

The present disclosure relates to a kinetic energy measurement device and a dragging force measurement system using the kinetic energy measurement device.

### BACKGROUND

Generally, a tailgate may be a door that is opened and closed, installed at the rear of a wagon-type vehicle, a van, or a recreational vehicle for storing cargo at the rear of a vehicle body, as shown in FIG. 1.

The tailgate (e.g., a tailgate 10) is installed to enable a driver to access a cargo compartment inside a vehicle cabin, and is mounted at the rear of the vehicle to enable a passenger to enter and exit the vehicle from the rear of the vehicle while facilitating loading or unloading of cargo into or from the cargo compartment.

In recent years, the tailgate has been equipped with a power tailgate system that automatically opens and closes the tailgate by a wired or wireless switch.

This power tailgate system may set the logic to reverse in the event of a pinching accident at the tailgate, and the logic may be a pinching accident prevention logic set to determine a rigid body without distinguishing between a person/object.

Therefore, to set the pinching accident prevention logic described above, it is necessary to measure a force generated by a power tailgate when pinching occurs by the power tailgate. However, a typical measuring device (e.g., FM 200, BIA class 1) may not be able to measure a dragging force, if occurs, due to a longer stroke, although it is able to measure values of an instantaneous strong force or gradually increasing force with a short stroke.

Moreover, in the case of a dragging force, which is a phenomenon in which a human body is dragged when a portion of the body is pinched during a closing operation of an electric door system such as a power tailgate, a power trunk, a power sliding door, and the like of a vehicle, applying a typical measuring device to a tailgate performing a circular arc motion as shown in FIG. 1 may not achieve accurate measurement.

This is because the typical measuring device is configured to measure only a linear motion and may thus not be able to measure a circular arc motion from which the dragging force described above is generated as the stroke becomes longer.

### SUMMARY

The present disclosure relates to measuring a force generated during a closing process of an electric door of an electric door system and, more particularly, to a kinetic energy measurement device and a dragging force measurement system using the kinetic energy measurement device, which measure quantitative data on a dragging force of a human body in the event of a portion of the body being pinched in an electric door during a closing operation of the door and quantify a reference value of a reversal force.

Embodiments of the present disclosure can solve the challenges described above.

An embodiment of the present disclosure can provide a kinetic energy measurement device and a dragging force measurement system using the kinetic energy measurement device, for measuring a force generated in a closing process of an electric door of an electric door system, which may measure quantitative data on a dragging force of a human body when a portion of the body is pinched in the door during a closing operation of the door based on an actual pinching situation and may quantify a reference value of a reversal force.

According to at least one embodiment of the present disclosure, a kinetic energy measurement device can include: an impact energy measurement unit configured to measure impact energy generated in a closing operation of an electric door; and a guide unit configured to support the impact energy measurement unit at a point on an opening or closing trajectory of the electric door.

The impact energy measurement unit may include: an impact detector configured to slide in a force direction by impact energy transmitted by an end portion of the electric door; and an impact absorber configured to absorb the impact energy transmitted to the impact detector.

The impact absorber may include: an elastic body configured to absorb the impact energy applied to the impact detector; and an elastic body support member configured to cause the elastic body to absorb the impact energy in the force direction.

The elastic body may comprise a coil spring or a shock absorber.

The guide unit may include a first directional fixing guide configured to allow a movement of the impact energy measurement unit in the force direction at a time of contact between the electric door and the impact energy measurement unit during the closing operation of the electric door, and a second directional fixing guide configured to allow a movement of the first directional fixing guide in a reaction direction by reaction of a dragging force generated on the trajectory of the electric door.

The kinetic energy measurement device may further include a stand configured to adjust a height of the second directional fixing guide.

The first directional fixing guide may include: a first directional guide configured to allow a movement of the impact energy measurement unit in the force direction; and a first directional guide fixer configured to prevent the first directional guide from being rocked.

The second directional fixing guide may include: a second directional guide configured to allow a movement of the first directional guide fixer in a forward and backward horizontal direction; and a second directional guide fixer configured to prevent the second directional guide from being rocked.

The first directional fixing guide may further include an operation direction mode changing bracket configured to selectively maintain a first direction and a second direction perpendicular or parallel.

The kinetic energy measurement device may further include a fixing bracket configured to fix or release the second directional guide fixer to or from the stand.

According to at least one embodiment of the present disclosure, a dragging force measurement system can include: a kinetic energy measurement device configured to measure a magnitude of a force generated at an end portion of an electric door in a closing operation of the electric door; a vector value extraction module configured to separate the magnitude of the force measured by the kinetic energy measurement device into a vector value; and a determination reference value setting module configured to set a dragging force determination criterion by measuring a force and energy variation based on the vector value extracted by the vector value extraction module. The kinetic energy measurement device may include: an impact energy measurement unit configured to measure impact energy generated in the closing operation of the electric door; and a guide unit configured to support the impact energy measurement unit at a point on an opening or closing trajectory of the electric door.

The vector value extraction module may be configured to acquire a first vector value that is based on kinetic energy of a force direction detected by the kinetic energy measurement device, and when there is a vector value other than the first vector value, separate this vector value and perform data processing thereon.

The determination reference value setting module may be configured to: set a criterion according to a variation in a current value for driving the electric door to determine a dragging force based on the vector value on which the data processing has been performed by the vector value extraction module.

At least one embodiment of the present disclosure can provide a kinetic energy measurement device and a dragging force measurement system using the same, for measuring a force generated during a closing process of an electric door of an electric door system, which may measure quantitative data on a dragging force of a human body during a closing operation of the door based on an actual situation where a portion of the human body is pinched in the electric door and may quantify a reference value of a reversal force.

### BRIEF DESCRIPTION OF THE DRAWINGS

FIG. 1 is a diagram illustrating an example of a typical tailgate.

FIG. 2 is a diagram illustrating a configuration of a dragging force measurement system according to an embodiment of the present disclosure.

FIG. 3 is a diagram illustrating a concept of a vector extracted by a vector value extraction module of a dragging force measurement system according to an embodiment of the present disclosure.

FIGS. 4 and 5 are perspective views of a kinetic energy measurement device of a dragging force measurement system in a state before measuring kinetic energy according to an embodiment of the present disclosure.

FIG. 6 is a perspective view of a kinetic energy measurement device of a dragging force measurement system in a state while measuring kinetic energy according to an embodiment of the present disclosure.

FIG. 7 is a side view illustrating the state shown in FIG. 6, with an example of sliding upward and downward and forward and backward.

FIG. 8 is a diagram illustrating an example of a dragging force measurement system applied to a sliding door according to an embodiment of the present disclosure.

FIGS. 9 and 10 are perspective views of a kinetic energy measurement device in a state while measuring kinetic energy when the example shown in FIG. 8 is applied.

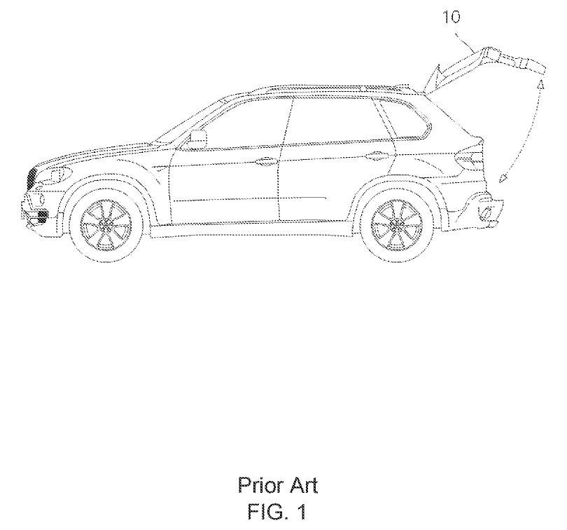

### DETAILED DESCRIPTION OF ILLUSTRATIVE EMBODIMENTS

Hereinafter, example embodiments of the present disclosure will be described in detail with reference to the accompanying drawings. Potential embodiments are not construed as necessarily limited to the disclosure and can be understood to include changes, equivalents, and replacements within the ideas and the technical scopes of the present disclosure.

Although terms including ordinal numbers, such as, "first," "second," and the like, may be used herein to describe various elements, the elements are not necessarily limited by these terms. These terms can be used merely to distinguish one element from another.

The term "and/or" is used to include any combination of multiple items that are subject to it. For example, "A and/or B" may include all three cases, for example, "A," "B," and "A and B."

When an element is described as "coupled" or "connected" to another element, the element may be directly coupled or connected to the other element. However, it is to be understood that another element may be present therebetween. In contrast, when an element is described as "directly coupled" or "directly connected" to another element, it is to be understood that there are no other elements therebetween.

The singular forms "a," "an," and "the" can include the plural forms as well, unless the context clearly indicates otherwise. It is to be further understood that the terms "comprises/comprising" and/or "includes/including" used herein specify the presence of stated features, integers, steps, operations, elements, and/or components, but do not preclude the presence or addition of one or more other features, integers, steps, operations, elements, components and/or groups thereof.

Unless otherwise defined, terms including technical and scientific terms used herein can have same meanings as commonly understood by one of ordinary skill in the art to which the present disclosure pertains. Terms, such as those defined in commonly used dictionaries, can have meanings that are consistent with their meaning in the context of the relevant art and the present disclosure.

A control unit, control device, or controller may include a communication device that communicates with another controller or a sensor to control a function assigned thereto, one or more memories that store an operating system (OS), a logic command, input/output information, and the like, and one or more processors that perform determination, calculation, computation, decision, and the like for controlling a function assigned thereto, for example.

A processor may include a semiconductor integrated circuit and/or electronic devices that perform at least one or more of comparison, determination, computation, and decision to achieve programmed functions, for example. A processor may be, for example, any one or a combination of a computer, a microprocessor, a central processing unit (CPU), an application-specific integrated circuit (ASIC), an electronic circuitry, and a logic circuitry.

Computer-readable recording media (or simply memory) (or non-transitory memory) (or storage medium) can include all types of storage devices that store data readable by a computer system, for example. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, optical disc, or any combination thereof, for example.

This recording medium may be electrically connected to the processor, and the processor may load and record data from the recording medium. The recording medium and the processor may be integrated or may be physically separated.

Hereinafter, a kinetic energy measurement device and a dragging force measurement system using the kinetic energy measurement device, according to example embodiments of the present disclosure, will be described in detail with reference to the accompanying drawings.

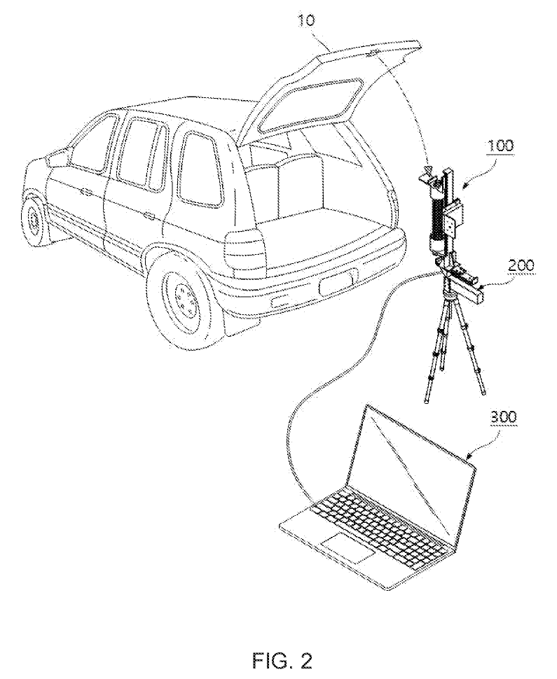

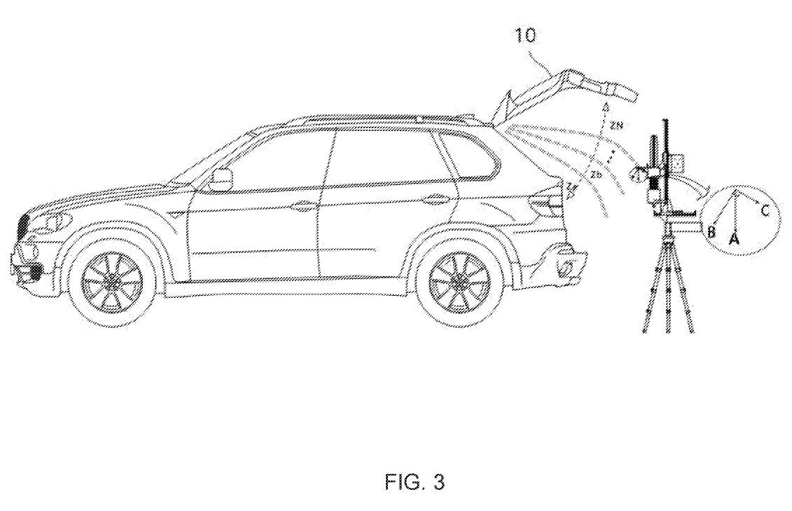

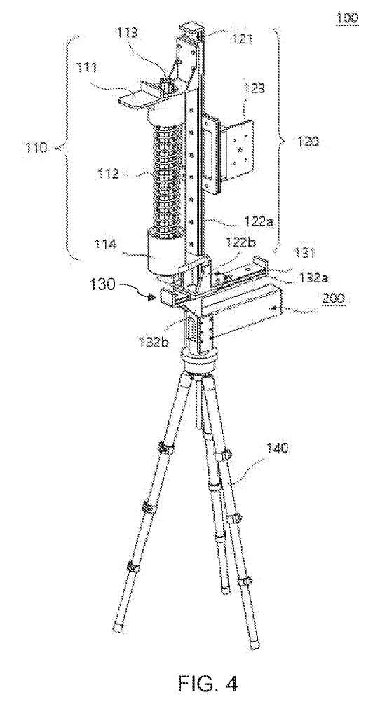

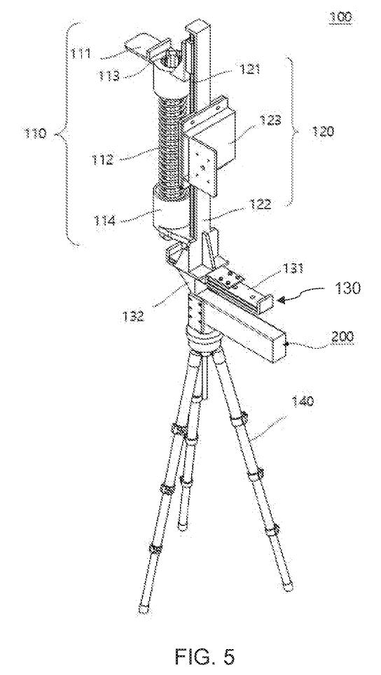

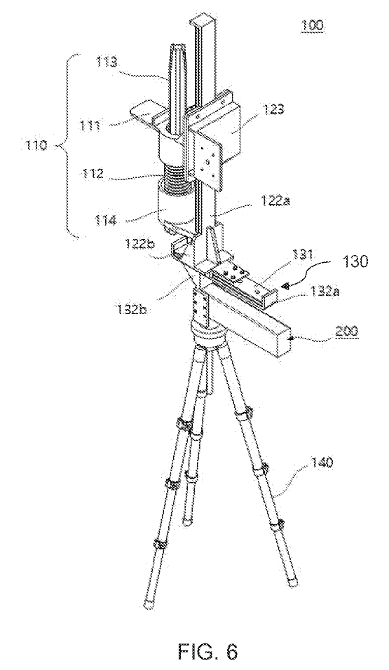

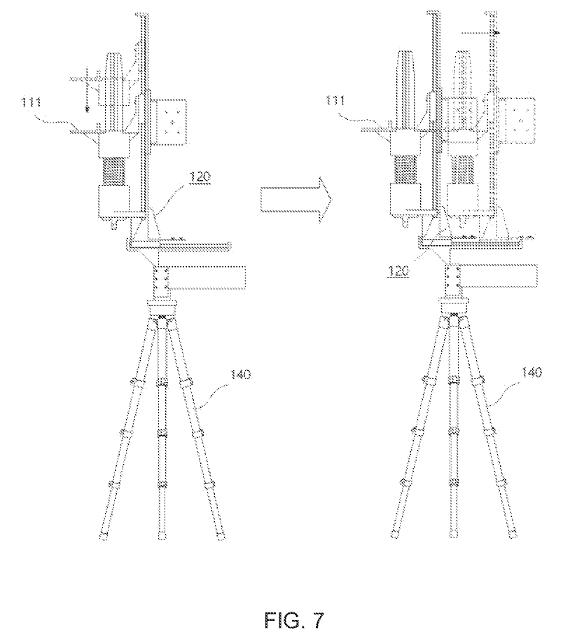

FIG. 2 is a diagram illustrating a configuration of a dragging force measurement system according to an embodiment of the present disclosure. FIG. 3 is a diagram illustrating a concept of a vector extracted by a vector value extraction module of a dragging force measurement system according to an embodiment of the present disclosure. FIGS. 4 and 5 are perspective views of a kinetic energy measurement device of a dragging force measurement system in a state before measuring kinetic energy according to an embodiment of the present disclosure. FIG. 6 is a perspective view of a kinetic energy measurement device of a dragging force measurement system in a state while measuring kinetic energy according to an embodiment of the present disclosure. FIG. 7 is a side view illustrating the state shown in FIG. 6, with an example of sliding upward and downward and forward and backward.

An overall configuration of a dragging force measurement system implemented according to an example embodiment of the present disclosure may include, as shown in FIG. 2: a kinetic energy measurement device 100 configured to measure a magnitude of a force generated at an end portion of a door 10 in a closing operation of the door 10 that performs an arc motion; a vector value extraction module 200 configured to separate the magnitude of the force measured by the kinetic energy measurement device 100 into a vector value; and a determination reference value setting module 300 configured to set a dragging force determination criterion by measuring a force and energy variation based on the vector value extracted by the vector value extraction module 200.

In this example, the vector value extraction module 200 may calculate vector values of reference numerals B and C based on a vector value of impact energy indicated by reference numeral A, as shown in FIG. 3.

For a dragging force, which is a phenomenon where a human body is dragged when a portion of the body is pinched during a closing operation of an electric door system, a vector value that may primarily cause the dragging force may be the vector value indicated by the reference numeral B, and a vector value that may secondarily cause the dragging force may be the vector value indicated by the reference numeral A.

That is, in the event of such a pinching accident by the electric door 10 that performs a circular arc motion, the vector value indicated by the reference numeral A may be a pressing force, and the vector value indicated by the reference numeral B may be a pulling force.

Because it is unknown at which position a pinching accident may occur, an operating zone of the door 10 shown in FIG. 3 may be divided into a plurality of zones (e.g., Za, Zb, ZN, etc.), and an impact amount generated by a circular arc motion of the door 10 in the event of a pinching accident occurring in each zone may be detected.

The vector value indicated by the reference numeral A may be maximal in the zone indicated by the reference numeral ZN and may be minimal in the zone indicated by the reference numeral Za. In contrast, the vector value indicated by the reference numeral B may be minimal in the zone indicated by the reference numeral ZN and may be maximal in the zone indicated by the reference numeral Za.

Accordingly, the vector value extraction module 200 may divide a first vector value A based on kinetic energy in a vertical direction detected by the kinetic energy measurement device 100 into a second vector value B of dragging to a trajectory of the arc motion and a third vector value C in a direction perpendicular to the second vector value B, and may perform data processing on the first vector value A and the second vector value B.

The determination reference value setting module 300 may set a criterion according to a variation in a current value for driving the door 10 to determine a dragging force based on the first vector value A and the second vector value B on which the data processing has been performed by the vector value extraction module 200.

It is to be noted that the modules described herein may each be implemented with a memory storing a program for performing corresponding functions and a processor executing the program, and respective memories of the modules may be integrated into one or more memories and respective processors of the modules may be integrated into one or more processors.

The preceding configuration of the kinetic energy measurement device 100 of the dragging force measurement system, according to embodiments of the present disclosure, is further described below with reference FIGS. 4-7. The kinetic energy measurement device 100 may be broadly divided into an impact energy measurement unit 110 configured to measure impact energy generated by a closing operation of the door 10 performing an arc motion, and a guide unit (e.g., 120 to 140) configured to support the impact energy measurement unit 110 at a certain point on a trajectory along the arc motion of the door 10.

The impact energy measurement unit 110 may include: an impact detector 111 configured to slide in a vertical direction by the impact energy transmitted by contacting the end portion of the door 10 performing an arc motion; an elastic body 112 configured to absorb the impact energy transmitted to the impact detector 111; and an elastic body support member 113 configured to allow the elastic body 112 to absorb the impact energy in the vertical direction without loss. A coil spring or a shock absorber may be used as the elastic body 112.

Any one of, but not limited to, a hydraulic damper and a pneumatic damper may be used as the shock absorber.

A fixing member 114 can be configured to fix the elastic body support member 113.

Further, the guide unit (e.g., 120 to 140) may include: a first directional fixing guide 120 configured to facilitate a smooth movement of the impact energy measurement unit 110 in the vertical direction at the moment when the door 10 and the impact energy measurement unit 110 are in contact during the closing operation of the door 10; a second directional fixing guide 130 configured to facilitate a movement of the first directional fixing guide 120 in a forward and backward direction such that the first directional fixing guide 120 can be pushed out by the force transmitted to the impact energy measurement unit 110 by a vector value of a force acting from the moment when the door 10 and the impact energy measurement unit 110 are in contact; and a stand 140 configured to adjust the height of the second directional fixing guide 130.

The first directional fixing guide 120 may include: a first directional guide 121 configured to facilitate a smooth movement of the impact detector 111 in the vertical direction; a first directional guide fixer 122 configured to prevent the first directional guide 121 from being rocked; and a mode change bracket 123 disposed at a rear end of the first directional guide fixer 122 and configured to change a mode to a horizontal measurement mode.

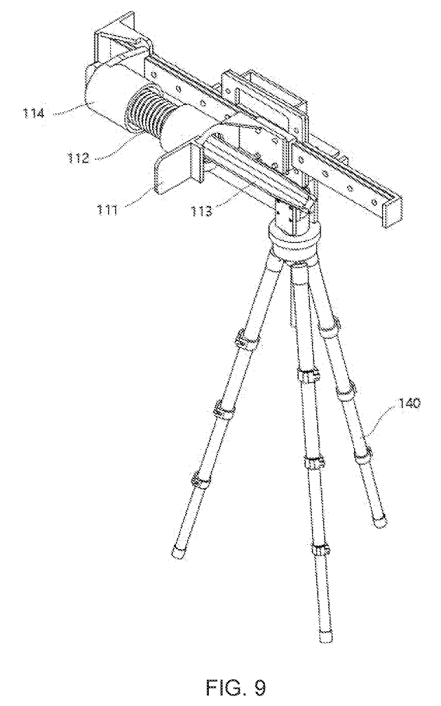

The mode change bracket 123 is described more below with reference to FIGS. 9-11.

The second directional fixing guide 130 may include: a second directional guide 131 configured to facilitate a smooth movement of the first directional guide fixer 122 in a forward and backward horizontal direction; and a second directional guide fixer 132 configured to prevent the second directional guide 131 from being rocked, and may further include a fixing bracket configured to prevent rocking (or shaking).

The second directional fixing guide 130 may be configured to facilitate a smooth movement of the first directional fixing guide 120 in a reaction direction by reaction corresponding to an action of a dragging force generated on the movement trajectory of the electric door 10, as shown in FIG. 7.

A connecting bracket may be further included to fix or release the second directional guide fixer 132 to or from the stand 140.

Further, the second directional guide fixer 132 may include: a connecting support 132b that is connected (or engaged) with the connecting bracket; and a second directional fixing support 132a provided in an integral form with the connecting support 132b and having the second directional guide 131 on one side thereof.

Further, the first directional guide fixer 122 may include: a sliding support 122b configured to slide along the second directional guide 131; and a first directional fixing support 121a provided in an integral form with the sliding support 122b and having the first directional guide 121 on one side thereof.

Thus, using an embodiment of the present disclosure, it can be possible to detect an impact amount in the vertical direction by the impact detector 111 at any position of the trajectory of the arc motion of the door 10, as shown in FIG. 3.

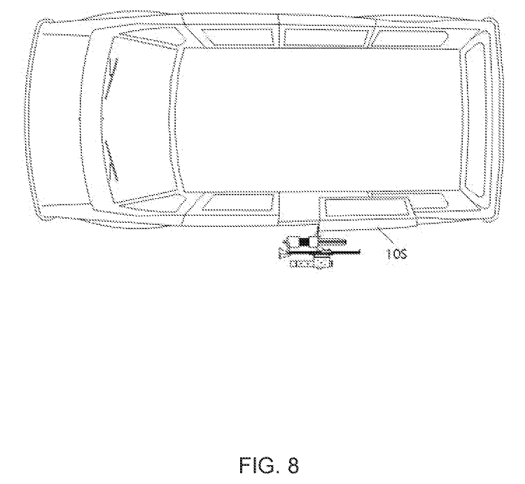

The kinetic energy measurement device and the dragging force measurement system using the kinetic energy measurement device, which are configured to operate according to embodiments of the present disclosure, may verify the reliability of a modified logic of a control logic, an example of which is described below with reference to FIG. 8.

According to an embodiment of the present disclosure, the dragging force measurement system may measure a force and energy variation in a situation where a body is dragged while being pinched, and a weak repulsive force is continuously generated and the stroke is prolonged, and may thereby establish a new reference of a reversal force based on the measured force and energy variation.

The preceding description provided with reference to FIGS. 2-7 can apply to an electric door that performs an arc motion, such as, for example, a tailgate, a trunk, or a bonnet.

On the other hand, the embodiments described with reference to FIGS. 8-10 focus on an example where the mode change bracket 123 is fixed to the second directional fixing guide 130 to detect an impact amount of a sliding electric door 10S that is opened and closed forward and backward. Accordingly, a first direction and a second direction may be parallel.

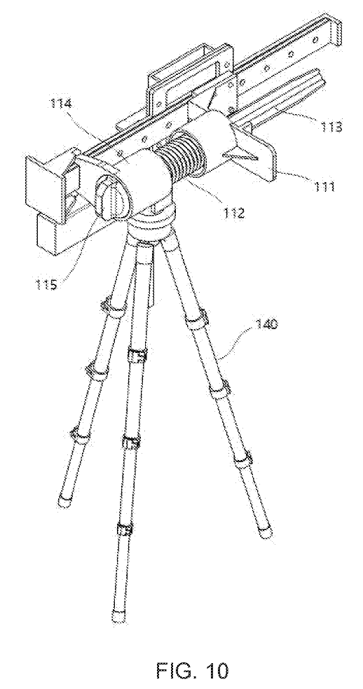

In FIGS. 9 and 10, reference numerals are assigned only to components included in the impact energy measurement unit and are omitted for others because the components can have substantially the same configurations and perform substantially the same operations already described.

On the other hand, an opening and closing member for replacement, indicated by reference numeral 115, may be configured to separate or combine the elastic body 112 and the elastic body support member 113 from or with the fixing member 114.

A number of embodiments have been disclosed herein. It can be understood that various features of the different embodiments can be combined. While example embodiments of the present disclosure have been shown and described above, the present disclosure is not necessarily limited to the specific example embodiments described above, various changes and modifications may be made by one of ordinary skill in the art to which the present disclosure pertains without departing from the spirit and scopes of the present disclosure, and such changes and modifications should not be construed as being independent of the technical ideas or views of the present disclosure.

What is claimed is:

1. A kinetic energy measurement device, comprising:
an impact energy measurement unit configured to measure impact energy generated in a closing operation of an electric door; and
a guide unit configured to support the impact energy measurement unit at a point on an opening or closing trajectory of the electric door.

2. The device of claim 1, wherein the impact energy measurement unit comprises:
an impact detector configured to slide in a force direction by impact energy transmitted by an end portion of the electric door; and
an impact absorber configured to absorb the impact energy transmitted to the impact detector.

3. The device of claim 2, wherein the impact absorber comprises:
an elastic body configured to absorb the impact energy applied to the impact detector; and
an elastic body support member configured to cause the elastic body to absorb the impact energy in the force direction.

4. The device of claim 3, wherein the elastic body comprises a coil spring or a shock absorber.

5. The device of claim 2, wherein the guide unit comprises:
a first directional fixing guide configured to allow a movement of the impact energy measurement unit in the force direction at a time of contact between the electric door and the impact energy measurement unit during the closing operation of the electric door; and
a second directional fixing guide configured to allow a movement of the first directional fixing guide in a reaction direction by reaction of a dragging force generated on the trajectory of the electric door.

6. The device of claim 5, further comprising a stand configured to adjust a height of the second directional fixing guide.

7. The device of claim 5, wherein the first directional fixing guide comprises:
a first directional guide configured to allow a movement of the impact energy measurement unit in the force direction; and
a first directional guide fixer configured to prevent the first directional guide from being rocked.

8. The device of claim 7, wherein the second directional fixing guide comprises:
a second directional guide configured to allow a movement of the first directional guide fixer in forward and backward horizontal directions; and
a second directional guide fixer configured to prevent the second directional guide from being rocked.

9. The device of claim 8, wherein the first directional fixing guide further comprises an operation direction mode changing bracket configured to selectively maintain a first direction perpendicular to or parallel to a second direction.

10. The device of claim 8, further comprising:
a stand configured to adjust a height of the second directional fixing guide; and
a fixing bracket configured to fix or release the second directional guide fixer to or from the stand.

11. A dragging force measurement system, comprising:
a kinetic energy measurement device configured to measure a magnitude of a force generated at an end portion of an electric door in a closing operation of the electric door;
a vector value extraction module configured to separate the magnitude of the force measured by the kinetic energy measurement device into a vector value; and
a determination reference value setting module configured to set a dragging force determination criterion by measuring a force and energy variation based on the vector value extracted by the vector value extraction module,
wherein the kinetic energy measurement device comprises:
an impact energy measurement unit configured to measure impact energy generated in the closing operation of the electric door, and
a guide unit configured to support the impact energy measurement unit at a point on an opening or closing trajectory of the electric door.

12. The system of claim 11, wherein the vector value extraction module is configured to:
acquire a first vector value that is based on kinetic energy of a force direction detected by the kinetic energy measurement device, and
based on there being a second vector value other than the first vector value, separate the second vector value and perform data processing thereon.

13. The system of claim 11, wherein the determination reference value setting module is configured to set a criterion according to a variation in a current value for driving the electric door to determine a dragging force based on the vector value on which data processing has been performed by the vector value extraction module.

14. A dragging force measurement system, comprising:
a kinetic energy measurement device configured to measure a magnitude of a force generated at an end portion of an electric door in a closing operation of the electric door, wherein the kinetic energy measurement device comprises:
an impact energy measurement unit configured to measure impact energy generated in the closing operation of the electric door, and
a guide unit configured to support the impact energy measurement unit at a point on an opening or closing trajectory of the electric door;
one or more processors; and
one or more storage mediums storing computer-readable instructions that, when executed by the one or more processors, enable the one or more processors to:
separate the magnitude of the force measured by the kinetic energy measurement device into a vector value, and
set a dragging force determination criterion by measuring a force and energy variation based on the vector value extracted.

15. The system of claim 14, wherein the instructions further enable the one or more processors to acquire a first vector value that is based on kinetic energy of a force direction detected by the kinetic energy measurement device.

16. The system of claim 15, wherein the instructions further enable the one or more processors to, based on there being a second vector value other than the first vector value, separate the second vector value and perform data processing thereon.

17. The system of claim 14, wherein the instructions further enable the one or more processors to set a criterion according to a variation in a current value for driving the electric door to determine a dragging force based on the vector value on which data processing has been performed.

18. The system of claim 14, wherein the impact energy measurement unit comprises:
an impact detector configured to slide in a force direction by impact energy transmitted by an end portion of the electric door; and
an impact absorber configured to absorb the impact energy transmitted to the impact detector, wherein the impact absorber comprises:
an elastic body configured to absorb the impact energy applied to the impact detector, and
an elastic body support member configured to cause the elastic body to absorb the impact energy in the force direction, wherein the elastic body comprises a coil spring or a shock absorber.

19. The system of claim 14, wherein the guide unit comprises:
a first directional fixing guide configured to allow a movement of the impact energy measurement unit in a force direction at a time of contact between the electric door and the impact energy measurement unit during the closing operation of the electric door; and
a second directional fixing guide configured to allow a movement of the first directional fixing guide in a reaction direction by reaction of a dragging force generated on the trajectory of the electric door.

20. The system of claim 19, wherein the first directional fixing guide comprises:
a first directional guide configured to allow a movement of the impact energy measurement unit in the force direction,
a first directional guide fixer configured to prevent the first directional guide from being rocked, and
an operation direction mode changing bracket configured to selectively maintain a first direction perpendicular to or parallel to a second direction;
wherein the second directional fixing guide comprises:
a second directional guide configured to allow a movement of the first directional guide fixer in forward and backward horizontal directions, and
a second directional guide fixer configured to prevent the second directional guide from being rocked; and
wherein the system further comprises:
a stand configured to adjust a height of the second directional fixing guide, and
a fixing bracket configured to fix or release the second directional guide fixer to or from the stand.
